(19) United States
(12) Patent Application Publication
(10) Pub. No.: US 2004/0177485 A1
(43) Pub. Date: Sep. 16, 2004

(54) Boot-slider

(76) Inventor: Yaron Lihod, Bet Arieh (IL)

Correspondence Address: DENNISON, SCHULTZ, DOUGHERTY & MACDONALD, 1727 KING STREET, SUITE 105, ALEXANDRIA, VA, 22314, US

(21) Appl. No.: 10/784,250

(22) Filed: Feb. 24, 2004

Related U.S. Application Data
(63) Continuation-in-part of application No. PCT/IL02/00711, filed on Aug. 28, 2002.

(30) Foreign Application Priority Data
Aug. 29, 2001 (IL) 145172

(51) Int. Cl. E21B 23/00; B23P 19/02

(52) U.S. Cl. 29/450; 29/235

(57) ABSTRACT

A tool for expanding flexible rubber boots such as cv boots, bellows and seals for easy mounting over and removal from mechanical joints including a mandrel having a base section with a perimeter having an opening and a plurality of spokes, each spoke being movably arranged with respect of the base section, to move from a first converged angle to a second open angle, and from a second open angle to a converged first angle, opening and closing the mandrel. The base section includes a crenellated rim with slots between adjacent crenellations, and the plurality of spokes are pivotally mounted in the slots between adjacent crenellations of the rim by pins, whereby the spokes can only pivot radially from a closed position to an open position with respect of the base section, and vice versa. A closing device exerts tension on the spokes to maintain the mandrel normally in a closed position and when the mandrel is opened by a drive mechanism in contact with the spokes, the device will urge the mandrel to close as the drive mechanism is retracted from the spokes.

This application is a continuation-in-part of PCT/IL02/00711 filed Aug. 28, 2002.

### FIELD OF THE INVENTION

The present invention relates to a mandrel and to a tool for tensioning elastic sleeves such as dust boots, bellows seals and the like, to ease their mounting around mechanical joints and connections, and further relates to a method of using such a device.

### BACKGROUND OF THE INVENTION

There are many elastic products used in mechanical devices, for covering and protecting joints. A widespread example of such an elastic product is the flexible boot used for enclosing and protecting the point of connection between the driveshaft and the ball joint in automobiles, but there are many other bellows seals, dust boots and the like used for similar purposes in a wide range of industrial and domestic machinery.

Installation and removal of bellows seals and dust boots around a joint, such as in a ball joint, without dismantling the joint, is not easy. One method commonly used for achieving this, is to turn the dust boot inside-out around a widening cone, and then back, outside-in, as it is mounted over the ball joint. This method is time-consuming, tiring for the mechanic and requires expertise. Furthermore, lubricating substances are often required to overcome friction when mounting the boot onto the widening cone, and this makes installation and removal a dirtying occupation.

It is to provide a fast, easy to use tool for facilitating the installation and removal of bellows seals, dust boots and the like, known hereinafter as flexible boots, around joints and other components, that the present invention is directed.

Numerous devices and apparatus have been described in which expansion pins, fingers or levers are mounted to a base and can be made to converge and diverge enabling them to stretch and mount O-rings, rubber tires and elastic sleeve ends.

DE 199 26 617 describes an expansion device for attaching rubber caps to drive links. The device has expansion pins held loosely in holes around the planar outer edge of a flange and a rigid anchoring mechanism to converge the pins. The pins converge and diverge by shifting their angle in the holes.

U.S. Pat. No. 3,605,239 discloses a bulky apparatus for installing resilient seals, such as O-rings. The apparatus includes thin elongated fingers whose base ends are coiled into springs and fixedly retained in a stressed position by a rigid retaining ring. The apparatus is unsuitable for positioning rubber boots over automobile drive shafts, and cannot be hand held. U.S. Pat. No. 2,574,195 describes a bulky apparatus with pivoting fingers for mounting tires onto the rim of wheels. The pivoting of the fingers, however, is restricted by slots in a work support.

GB 1,033,508 discloses an apparatus for positioning a circumferential end of a tube, whose other end is sealed, over a wider body. The apparatus has curved levers with hooked ends pivotally connected to the planar circumference of a ring and extending beyond the perimeter of the ring. The levers cannot extend into the full interior of a tube and therefore cannot be used to mount tubular structures over objects such as mechanical joints.

Japanese patent publication JP 01064735 discloses an apparatus for a similar purpose as that of this invention. However, the structure of the apparatus is completely different. According to this patent, the spokes or fingers can pivot radially only a short distance because their pivot points are close to their centers not at the terminal ends. Therefore, they cannot converge to a cone shape, which limits the type of rubber boots that can be applied with this apparatus. Moreover, the present invention provides a closing device to maintain the spokes normally in a converged (cone shaped) state, and to return the spokes from an expanded state to converged state when a piston is withdrawn from the spokes.

### SUMMARY OF THE INVENTION

It is an aim of the present invention to provide a tool for facilitating the installation and removal of expandable sleeves such as flexible boots to and from their position around driveshafts, joints and the like, particularly on automobiles.

It is another aim of the present invention to provide such a tool that is easy to use.

It is a further aim of the present invention to provide such a tool that requires no special training to become proficient in its use.

It is yet another aim of the present invention to provide such a tool hat requires little physical exertion on the part of the operator to operate the tool.

It is still a further aim of the present invention to provide such a tool that does not require the use of grease or lubricants to maneuver and position flexible boots.

A further object of the invention is to provide a method of installing and removing expandable sleeves, such as flexible boots, to and from their position external to driveshafts, joints and the like.

In a first aspect of the present invention, there is provided a mandrel for expanding elastic sleeves for easy mounting over and removal from mechanical joints, comprising a base section having a perimeter with an opening therein and a plurality of spokes; each spoke being movably arranged with respect of the base section, such that the mandrel can alternate between a closed state and an open state; such that in the closed state, the plurality of spokes converge at their far ends to form a cone shape and each spoke forms a first angle with the base section, and in the open state, the plurality of spokes move in the opposite direction to assume a second angle with the base section that is substantially larger than the first angle, characterized in that, the base section comprises a crenellated rim with slots between adjacent crenellations,

the plurality of spokes are pivotally mounted at their base ends in the slots between adjacent crenellations of the rim by pins whereby the spokes can pivot only radially to a closed cone position and to an open expanded position, respectively, with respect of the perimeter of the base section, and

a separate closing device is provided to exert a force that serves as a piston returning means for returning a piston from a forward position to a backward position, and for maintaining the mandrel in a closed state.

The closing device is preferably made of rubber and is preferably also a guard element circumscribing the base element and covering at least a section of each of the spokes to protect the pivotal joints and to limit the second open angle of the pivotal spokes. This guard element is resilient, such that it is expanded when the mandrel is in the open position and contracts when the mandrel is in the closed position, urging the spokes to converge.

Alternatively, the closing device may be a plurality of springs, which may be used alone or in combination with a rubber guard element.

Typically, the mandrel will have 3 to 12 spokes equidistantly spaced around the perimeter of the base element.

Preferably, the spokes are detachable from the base section.

The invention further comprises a tool for mounting boots, bellows and seals in automobiles is handheld and comprises a mandrel as described hereinbefore and a drive mechanism for opening the mandrel by pivoting the spokes from a first closed angle to the second open angle and for allowing the spokes to converge from the second angle to the first angle.

The apparatus for opening the mandrel is preferably a piston that reciprocates between a forward position and a backward position, and preferably, there is further provided a driving apparatus for driving the piston, that will typically comprise elements selected from worms, gears, levers, pneumatic apparatus and hydraulic apparatus.

Where hydraulically or pneumatically driven, the driving apparatus comprises a fluid flow regulator attachable to a compressor.

This regulator may comprise an upper chamber having a fluid outlet that is connectable to a connector; a lower chamber having a fluid inlet connectable to the compressor; a conduit having a non-return valve therein, connecting said lower chamber to said upper chamber, enabling fluid to flow from the compressor to the connector; an isolation valve for isolating the upper chamber from the lower chamber, and a release valve for venting the upper chamber.

The non-return valve described above may include a sphere in the conduit, such that when the isolation valve is in an open state, fluid freely flows pas past the sphere, and when isolation valve is in a closed state, the sphere is wedged into the conduit, blocking fluid flow.

The release valve may comprise a hole through the wall of the regulator, and a tapering peg that blocks the hole, such that pressure by an operator on the peg allows air to escape from the upper chamber through the hole.

In another aspect, the invention also relates to a method for expanding elastic sleeves and mounting same over a mechanical joint comprising the steps of:

I. providing:

a) a mandrel, comprising:

1) a base section defining a perimeter with an opening therein and comprising a crenellated rim with slots between adjacent crenellations,

2) a plurality of spokes pivotally mounted in slots between adjacent crenellations of the rim by pins whereby the spokes can pivot radially to a closed cone position and to an open expanded position, respectively, with respect of the base section, and

3) a separate closing device exerting tension on the spokes to maintain the mandrel normally in a closed position, and

b) drive mechanism for driving a piston in contact with the spokes to reciprocate between a forward position and a backward position for opening the mandrel and causing the spokes to move from a first converged angle to a second open angle;

II. sliding a flexible elastic sleeve over the plurality of spokes of the mandrel when they are in their converged position;

III. extending the piston of the drive apparatus forward to urge the spokes to pivotally diverge radially outward, thereby expanding the elastic sleeve and providing an enlarged inner sleeve cavity;

IV. placing the mandrel with the diverged spokes supporting the expanded sleeve over a mechanical joint so that the joint lies within the enlarged inner sleeve cavity,

V. retracting the piston, whereby the closing device urges the spokes to converge, allowing the elastic sleeve to contract over and around the mechanical joint, and withdrawing the mandrel, leaving the joint enveloped by the sleeve.

A particular method for expanding elastic sleeves and mounting same over mechanical joints (typically including a driveshaft) comprises the steps of:

(a) providing:

(i) a mandrel comprising a base section with an opening therethrough mounted on a cylinder having a crenellated rim and a plurality of substantially rigid spokes having base ends and far ends, the base ends being pivotally attached by pivotal joints to the base section, around its perimeter within slots between adjacent crenellations, such that the spokes can pivot to converge to a first closed position, forming a cone shape, and can pivot to a second open position;

(ii) a closing device associated with the mandrel for urging the plurality of spokes to a closed position comprising a resilient guard element surrounding at least a portion of each of the plurality of spokes, to protect the pivotal joints, keep the spokes closed when the mandrel is in an inoperative position, and to restrict the degree of divergence of the spokes when in the open position, and

(iii) a piston for reciprocation through the base section between a forward position and a backward position, such that when the piston is moved forward it urges the spokes apart and the mandrel assumes an open position, and when the piston is moved backward, the resilient guard element urges the spokes to reassume a closed position,

(iv) a driving apparatus for driving the piston, which is typically a pneumatic apparatus or a hydraulic apparatus,

(b) closing the mandrel by bringing spokes into their convergent position;

(c) sliding a flexible elastic sleeve over the plurality of spokes of the mandrel;

(d) urging the spokes to pivotally diverge outward thereby expanding the elastic sleeve and providing an enlarged inner sleeve cavity;

(e) placing the diverged spokes with expanded sleeve over the mechanical joint, so that the mechanical joint lies within the enlarged inner sleeve cavity;

(f) pivotally converging the spokes by retracting the piston, thereby allowing the sleeve to contract over and around the mechanical joint, and

(g) withdrawing the mandrel, leaving the joint enveloped by the sleeve.

Another method for fixing a flexible boot over the head of and around a driveshaft comprises the steps of:

(a) Providing:

(i) a mandrel and drive mechanism as hereinbefore defined, and

(ii) a compressor with a fluid flow regulator, said regulator comprising an upper chamber having a fluid outlet that is connected to a connector; a lower chamber having a fluid inlet connected to the compressor; a conduit having a non-return valve therein, connecting said lower chamber to said upper chamber, enabling fluid to flow from the compressor to the connector; an isolation valve for isolating the upper chamber from the lower chamber, and a release valve for venting the upper chamber;

(b) Sliding a flexible boot over the cone formed from the closed pivoted spokes of the mandrel;

(c) Opening the isolation valve of the regulator, allowing fluid to enter the fluid intake of the lower chamber of the regulator from the compressor, from whence the fluid is forced through the non-return valve, into the upper chamber of the regulator and thence through the connector, to the cylinder of the boot slider, forcing the piston from its backwards position into its forward position, forcing the mandrel to assume the open state, and stretching the flexible boot in so doing;

(d) Inserting the head of the driveshaft through the opened mandrel and flexible boot stretched therearound, and

(e) Venting fluid from the upper chamber of the regulator via the release valve, thus allowing the piston to return to its backward position in the cylinder under influence of the closer, thus allowing the pivoting spokes of the mandrel to converge, and the mandrel to assume its closed state, releasing the flexible boot into its correct position.

The fluid flow regulator for connecting the tool to a compressor, comprises:

(i) an upper chamber having an outlet therefrom that is connectable to said tool;

(ii) a lower chamber having an inlet thereto that is connectable to said compressor;

(iii) a conduit connecting said lower chamber to said upper chamber, allowing fluid to flow therethrough, from said compressor to said upper chamber; said conduit having (iv) a non-return valve therein;

(v) an isolation valve for isolating the upper chamber from the lower chamber, and

(vi) a release valve for venting the upper chamber.

The non-return valve may comprise a sphere in the conduit, such that when isolation valve is in an open state, compressed fluid freely flows past the sphere, but when isolation valve is in a closed state, the sphere is wedged into the conduit, blocking it.

The release valve may comprise a tapering peg that blocks a hole through a wall of the regulator; said hole connecting said conduit to outside of said regulator, such that pressure by an operator on the peg, allows fluid to escape from said upper chamber through said hole.

The term “flexible boot” is used hereinafter, to imply dust boots, cv boots, bellows, seals, sleeves, washers and all other similar elastic or rubber components of mechanical apparatus, that require stretching for installing and removing over the components and connections that they are designed to protect.

### BRIEF DESCRIPTION OF THE DRAWINGS

The present invention will be further understood and appreciated from the following detailed description taken in conjunction with the drawings in which:

FIG. 1 is an exploded isometric projection of a first embodiment of the present invention in the open position;

FIG. 2 is an exploded cross-sectional view of the embodiment of FIG. 1;

FIG. 3 is an isometric projection of the assembled embodiment of FIG. 1 in the closed position;

FIG. 4 is an isometric projection of the assembled embodiment of FIG. 1 in the open position;

FIG. 5 is closed isometric projection of FIG. 3 with a dust boot positioned over the closed spokes of the mandrel;

FIG. 6 is a cut-away isometric projection of FIG. 4 with a dust boot positioned over the open spokes of the mandrel, and a driveshaft positioned within receptacle of the piston;

FIG. 7 is an exploded isometric projection of a second embodiment of the present invention;

FIG. 8 is a schematic cross-sectional view of a regulator for connecting the device of FIGS. 1 to 6 to a compressor;

FIG. 9 is an exploded isometric projection view of the regulator shown in FIG. 8; and

FIG. 10 is a flow chart showing how a flexible boot can be correctly positioned using a pneumatic boot slider in accordance with the present invention.

### DETAILED DESCRIPTION OF THE INVENTION

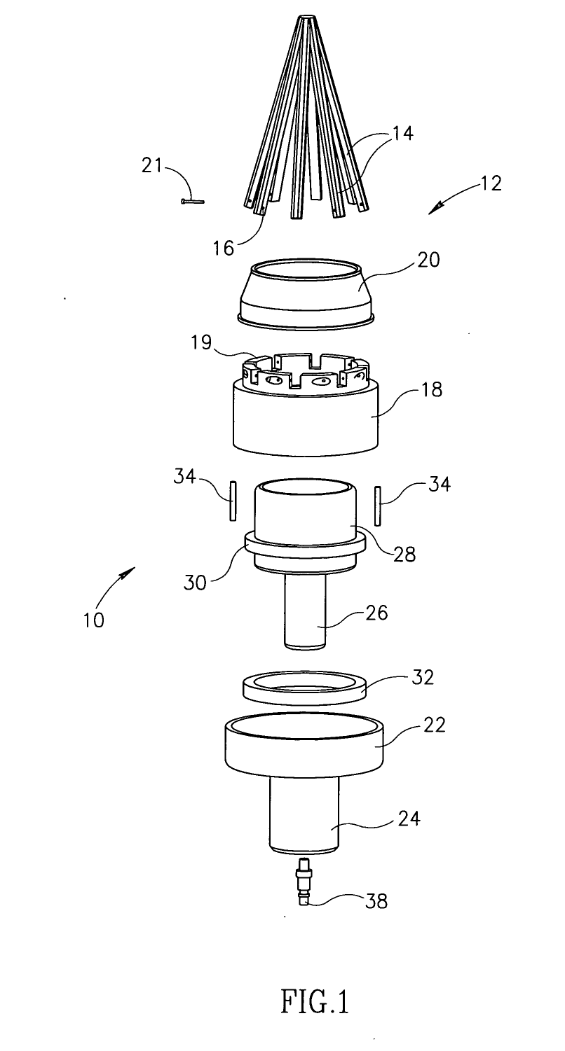

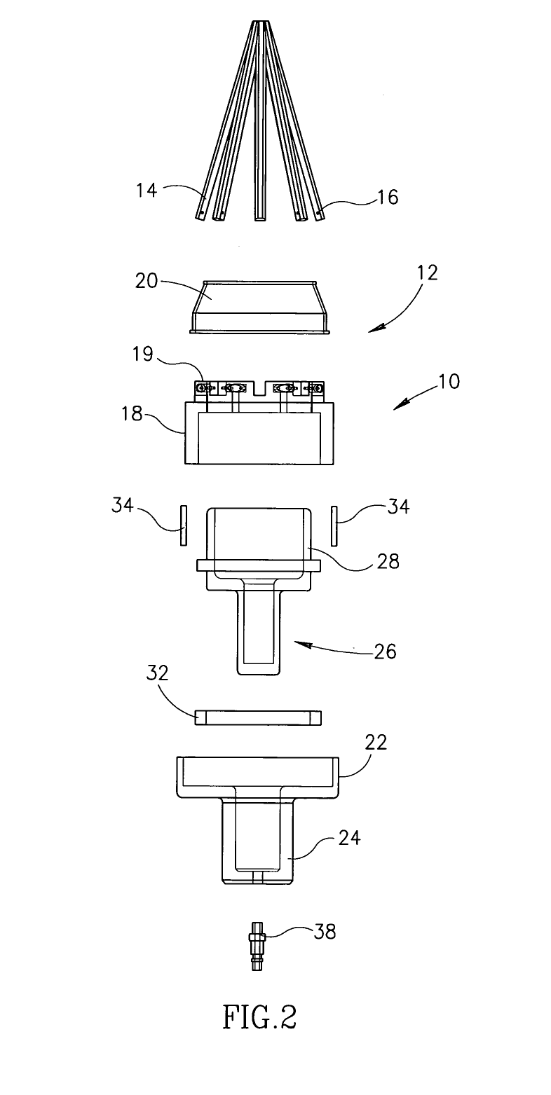

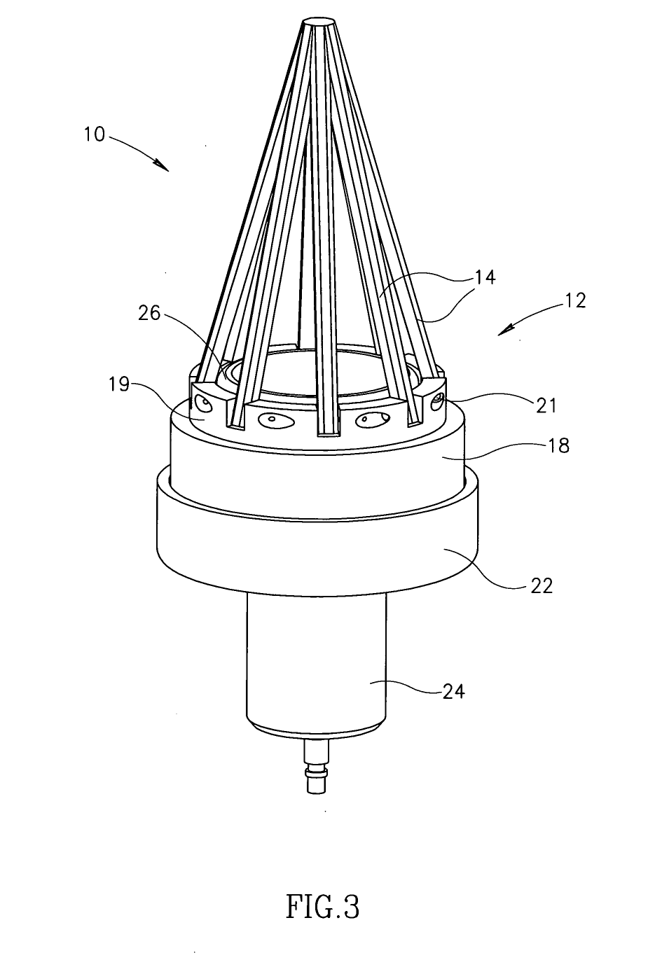

FIGS. 1 to 6 show a preferred embodiment of the present invention, known hereinafter as a boot slider. The same parts are annotated by the same reference numbers in all diagrams, but to best appreciate the construction, reference is first made to FIGS. 1 and 2 showing the parts and construction of the boot slider 10 in expanded, isometric projection and cross-sectional view respectively. Thus referring to FIGS. 1 and 2, there is shown, a preferred embodiment of the boot slider 10 consisting of a mandrel 12 that is formed from a plurality of spokes 14, each having a hole 16 therethrough, near the base ends 15 thereof. There is also shown a base 18 in the form of an annulus having a crenellated rim 19, allowing the affixation of each pivoting spoke 14, within a slot 23 between adjacent crenellations, by a pin 21 (FIG 3). Fitting over and around the crenellated rim 19 of the base 18, there is provided a resilient guard element 20, illustrated herein as an annular ring 5 with a truncated conical extension 7 covering at least a portion of the spokes 14 that prevents the plurality of spokes from pivoting outwards from the base and urge them to converge to a cone shape. The base 18 is affixed into the expanded mouth 22 of a cylinder 24, within which there is provided a piston 26 that can reciprocate between a forward position and a backward position within the cylinder 24. The mouth of the piston 26 widens into a receptacle 28. Extending outwards from the piston 26, around the base of the receptacle 28 there is provided a flange 30. Below the piston flange 30, to provide sealing between piston 26 and cylinder 24, there is provided a gasket 32. Also provided, there is at least one closing device 34 that serves as a piston returning means, for returning the piston from its forward position to its backwards position. As illustrated herein, the closing device 34 may be a plurality of springs that fit around the outside of the receptacle 28 and within the base 18, such that when piston 26 is in its forward position, the closing device 34 exerts a force on the piston flange 30, that tends to drive the piston backwards. Affixed to the base of the cylinder 24, there is shown a connector 38, allowing the boot slider 10 to be connected, via an appropriate regulator, to a source of compressed air or a fluid, for pneumatic or hydraulic operation.

The guard element 20 may be made of a resilient material such as rubber for example. Other parts will generally be made of metal/alloy, such as steel, but alternatively, could be fabricated from other materials such as an engineering plastic.

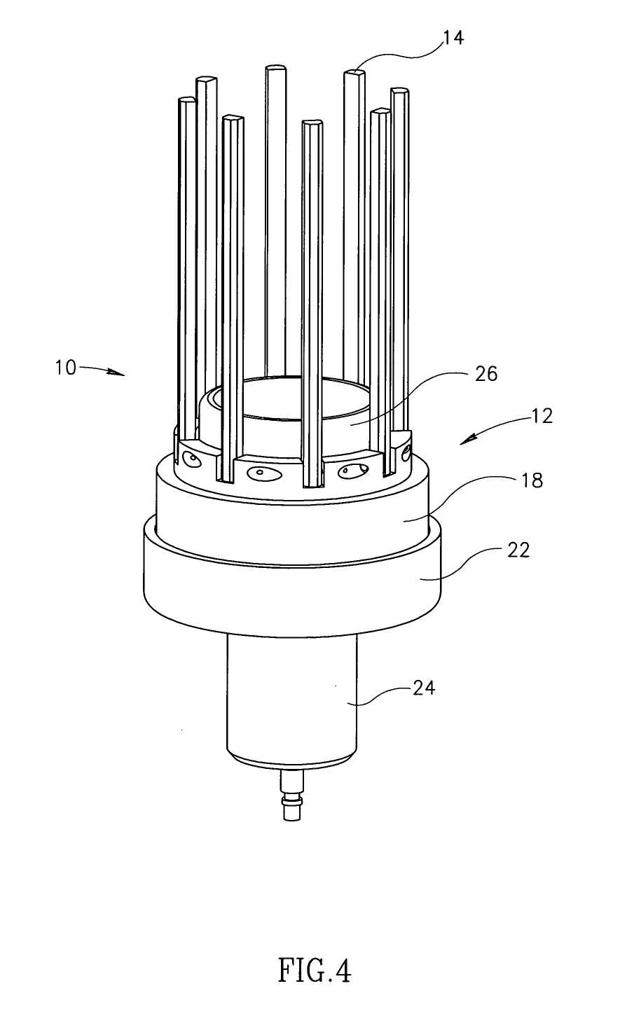

Referring now to FIGS. 3 and 4, showing the assembled boot slider 10 with guard element 20 removed for clarity. The mandrel 12 can assume two states: a closed state (FIG. 3), and an open state (FIG. 4). In the closed state (FIG. 3), the piston 26 is in its backwards position, and the spokes 14 of the mandrel 12 are pivoted inwards, so that they converge towards each other, each spoke 14 situated at an acute angle with the base 18, and the mandrel 12 having a conical or frustoconical shape.

In the open state (FIG. 4), the piston 26 is in its forwards position, and the spokes 14 of the mandrel 12 are forced open, so that each spoke 14 is situated at a larger angle with the base 18 than in the closed state and the spokes 14 of the mandrel 12 are less convergent than in the closed state. As illustrated herein, in the open state, the spokes 14 lie perpendicular to the base 18, the mandrel 12 assuming an essentially cylindrical shape.

It will be appreciated however, that the terms “open” and “closed” are relative, with the degree of opening being a function of the length of the spokes, the height of the guard element and the size and shape of the base, and the degree of opening and closing desired are application specific. The spokes of the mandrel in the open state may converge at a shallower angle to the convergency of the closed state. Alternatively, they may lie parallel to each other, or they may diverge, the mandrel assuming a reversed frustoconical shape thereby.

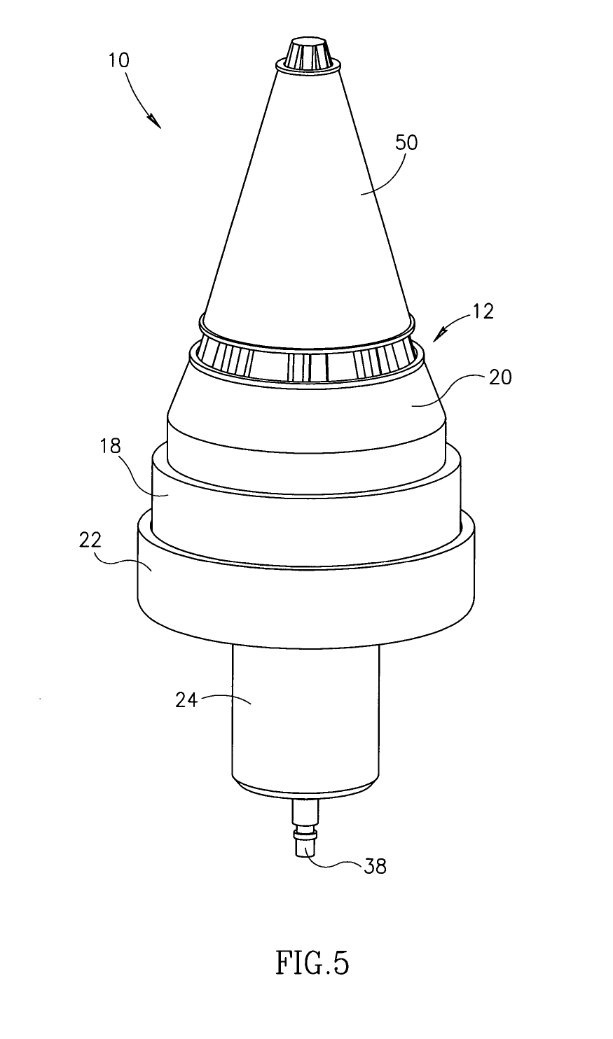

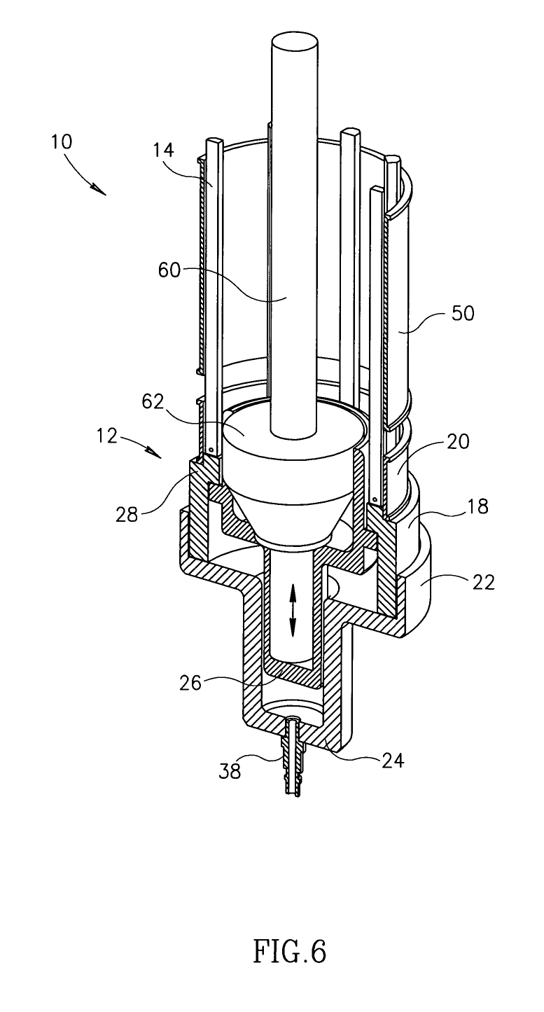

Referring now to FIG. 5, the boot slider 10 is shown in its closed state with a conical flexible boot 50 placed over the conical converging spokes 14 of the mandrel 12. Driving the piston forwards within its cylinder, forces the spokes 14 to open up radially, and the mandrel 12 assumes its open state, shown in FIG. 6, with the stretched flexible boot 50 pulled into a cylindrical shape. Due to the wide mouthed receptacle 28 at the end of the piston 26, the bulbous head 62 of a large driveshaft 60 can be accommodated within the receptacle 28.

It will now be apparent that the boot slider 10 allows a flexible boot 50 to be stretched open, so that a driveshaft 60 can be passed therethrough, facilitating the correct positioning of the flexible boot 50 around a joint with ease.

Having disclosed the device shown herein, it will be appreciated that the basic design of the boot slider illustrated herein, is subject to many modifications. The sleeve and pivoting shafts may be co-engineered to allow the shafts to “close” and “open” to other angles, wider or narrower than the angles illustrated in FIGS. 2 and 4, for example. Furthermore, although FIG. 6 shows a flexible boot being positioned over a driveshaft, the boot slider disclosed herein is readily adaptable to other applications requiring the stretching and positioning of a flexible boot or similar elastomeric or rubbery sleeve for protecting or covering other machine parts.

A plurality of spokes are required to provide the mandrel of the boot slider for tensioning flexible boots. In the embodiment shown herein in FIGS. 1 to 5, eight spokes 12 are shown. For most applications, the exact number is not critical.

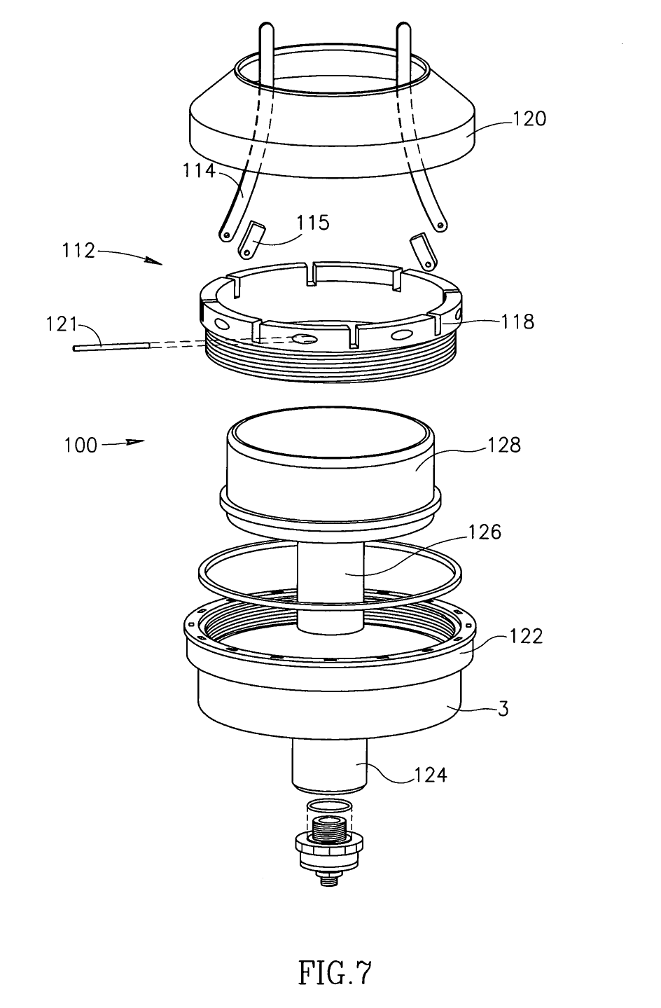

With reference to FIG. 7, there is shown a second embodiment wherein, the spokes 114 of the mandrel 112 are not directly connected to the base 118 of the boot stretcher 100, but fit into arm guides 115. Being detachable, the number of spokes can be varied for different applications. Minimally, as shown herein, 2 spokes are required, but for most applications, a larger number is preferable. The crenellated base 118 as illustrated, can accommodate up to 8 spokes. Other bases may be fabricated to accommodate other numbers. Furthermore, the guard element 120 comprises a truncated cone section 7 integral with an annular ring section 5 for covering the crenellated base 18 and is manufactured from an elastic material, such as rubber, and is designed to resist deformation to the extent that, in addition to resisting the spokes 114 of the mandrel 112 from opening to too large an angle, the guard element 120 further serves as a closing device, causing the spokes 14 to converge and the mandrel to assume its closed state when the extending force on the piston 126 is relieved. No further closing device is required, and the base 118 may be rigidly attached to the expanded mouth 122 of the cylinder 124, by a screw-thread, for example. This lack of additional, separate closing device is in contradistinction to the additional closing device 34 distinct from the guard element 120, that is a requirement of the first embodiment described hereinabove, and illustrated as a plurality of springs in FIGS. 1 and 2.

It will be appreciated, that the operating force for forcing the piston forwards within the cylinder to open the pivoting shafts, may conveniently be applied by a variety of driving systems, including mechanical means, such as a worm, which may be motorized or hand-operated. Alternatively, the forward urging force may be applied by a class one lever, such as a pincer/plier type of apparatus including a pair of handles arranged to pivot around an axis below the piston. Mechanical means may also include gear systems and other elements as known in the art.

For convenience and ease of use however, in workshops having suitable auxiliary equipment, a driving system utilizing hydraulic pressure or pneumatic pressure may be used.

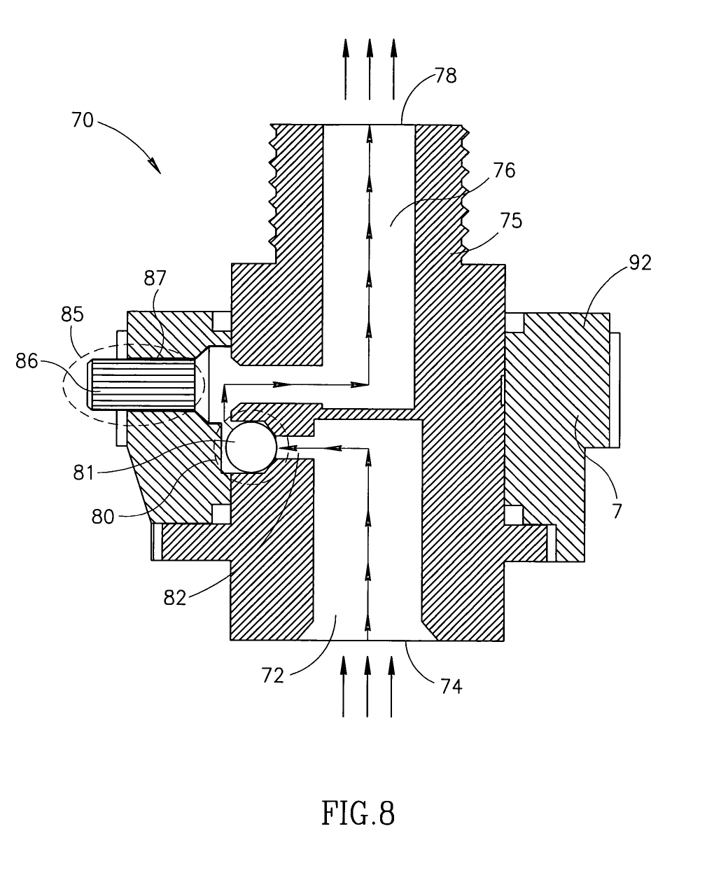

Referring now to FIG. 8, there is shown, in schematic cross-section view, a regulator 70 for connecting the boot slider 10 to an air compressor (not shown), it being appreciated that car workshops are generally fitted up with air compressors. The regulator 70 has two chambers connected by a conduit 82 containing a non-return valve and a release valve 85 a lower chamber 72 having an air intake 74 thereto, for connecting to the compressor, and an upper chamber 76 having an air outlet 78 therefrom, that connects to the air connector 38 of the boot slider 10 (see FIGS. 1-5). As illustrated herein, the regulator 70 is coupled to the air connector 38 using a screw threaded fitting 75, but any other suitable coupling means known in the art, such as an appropriate quick-fit mechanism may be used.

The first chamber 72 is connected to the second chamber 76 via a non-return valve, illustrated herein as a unidirectional ball valve 80, consisting of a sphere 81 in the conduit 82. The ball valve 80 allows air to flow through the regulator 70 from the compressor to the boot slider, but not back again. Also provided there is a middle part 92 that serves as an isolating valve, that enables isolation of the upper chamber 76 from the lower chamber 72 by it being rotated, and an air release valve 85 that allows compressed air from the upper chamber 76 to be vented, releasing the pressure in the upper chamber.

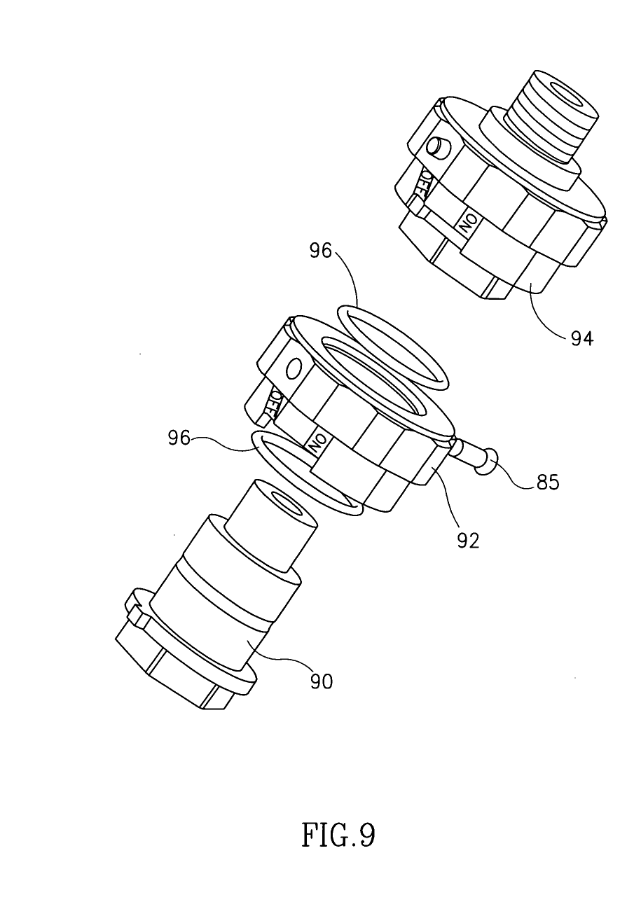

FIG. 9 shows the components required to manufacture an exemplary regulator of this type for connecting the boot slider to a source of compressed air, wherein the regulator comprises a bottom part 90, a middle part 92 and an upper part 94 that interlock together, gaskets 96 being provided between the parts to provide air-tight sealing. Also shown is the release valve 85. Of note in the novel regulator illustrated, the release valve 85 sits in the same conduit as the ball valve 80. The ball valve consists of a sphere 81 that sits in the conduit 82 between the bottom part 90 and middle part 92, allowing air to flow therethrough when the regulator 70 is in the open position. Rotating the regulator into the closed position causes the sphere 81 to be tightly wedged into the conduit 82, thereby closing off the conduit 82 and isolating the upper chamber 76 from the lower chamber 72. The release valve 85 consists of a tapering peg 86, typically having a somewhat frustoconical geometry that fits into a hole 87 connecting the conduit 82 to the outside of the regulator 70. Air pressure within the upper chamber 76 keeps the tapering peg 86 pushed outwards, and tightly rammed against the wall of the hole 87. When the regulator 70 is in the closed position however, with the middle part 92 being rotated, causing the sphere 81 to be blockingly wedged into the conduit 82, the tapering peg 86 may be pushed inwards by the operator, allowing air trapped in the upper chamber 76 to be vented through the hole 87 to the outside, and thereby releasing the pressure on the cylinder, allowing it to move backwards within the piston, and thereby allowing the mandrel to reassume its closed state.

The compressed air flow regulator described hereinabove thus serves to regulate the mechanical means for opening the mandrel, moving the array of spokes thereof, from their closed position to their open position. This, together with the closing means, generally a resilient device that resists deformation, such as a spring, that moves the array of spokes from their open position to their closed position, provide a system for opening and closing the mandrel.

Hydraulic systems similar in function to the pneumatic system described above may be used instead.

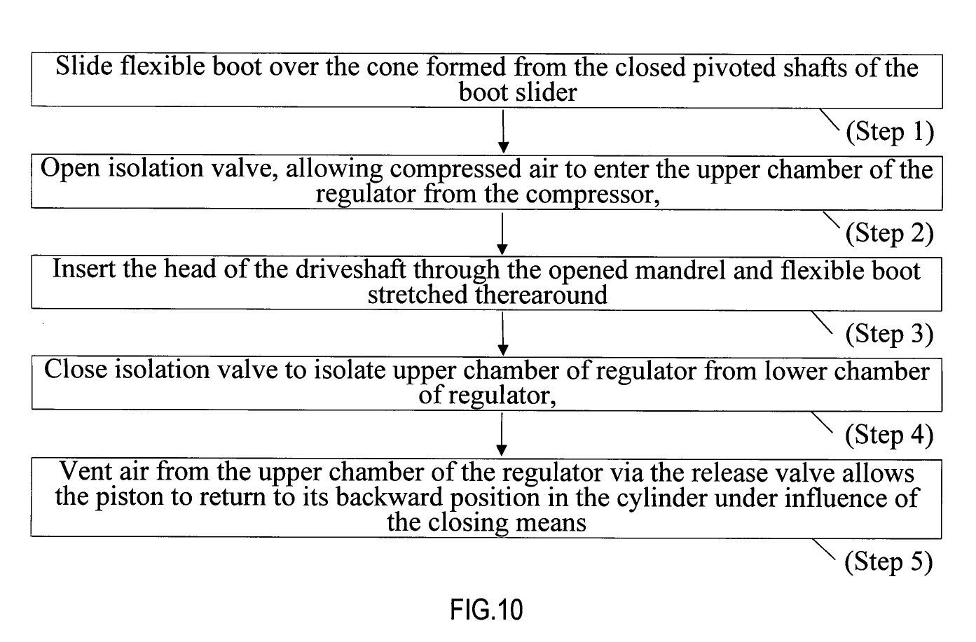

Referring now to the flow diagram of FIG. 10, and referring back to FIGS. 1-6, to operate the boot slider 10 pneumatically, the following steps are required:

(Step 1) A flexible boot is slid over the cone formed from the closed pivoted shafts of the boot slider (FIG. 5).

(Step 2) The isolation valve of the regulator is opened, allowing compressed air to enter the upper chamber of the regulator from the compressor, and thence through the connector, to the cylinder of the boot slider. The compressed air entering the boot slider forces the piston from its backwards position into its forward position, forcing the spokes 14 of the mandrel 12 to assume the open position (FIG. 4), stretching the flexible boot 50 in so doing.

(Step 3) The head 62 of the driveshaft 60 may now be inserted through the opened mandrel 12 and flexible boot 50 stretched therearound, into the wide mouthed receptacle 28 at the end of the piston 26.

(Step 4) Closing the isolation valve, thus isolating upper chamber of regulator from the lower chamber thereof.

(Step 5) Venting air from the upper chamber of the regulator via the release valve, thus allowing the piston 26 to return to its backward position in the cylinder 24 under influence of the closing means 34.

This allows the pivoting spokes 14 of the mandrel 12 to converge, and the mandrel 12 to assume its closed state, releasing the flexible boot 50 into its correct position.

It will be appreciated of course, that in alternative embodiments, the system for opening and closing the mandrel may be configured in many diverse ways which, though structurally different, are, nevertheless functionally equivalent. Thus the closing means may be a piston with an appropriate driving system, whether mechanically, hydraulically or pneumatically driven, and the opening means may be a resilient member that resists deformation and acts as a counter to the closing means.

Additionally, the novel regulator illustrated in FIGS. 8 and 9 may, perhaps with minor alterations, be applied to allow the pneumatic operation of other power tools.

It will be appreciated therefore, that the invention is not limited to what has been described hereinabove merely by way of example. Rather, the invention is limited solely by the claims which follow, wherein the word comprise and variations thereof, such as comprises, comprising and the like, imply that the specified components or steps are included, but not generally to the exclusion of other components or steps.

What is claimed is:

1. A mandrel (12) for expanding flexible rubber boots (50) such as cv boots, bellows and seals for easy mounting over and removal from mechanical joints comprising a base section (18) having a perimeter with an opening therein and a plurality of spokes (14), each spoke being movably arranged with respect of the base section (18) to move from a first converged angle to a second open angle, and from a second open angle to a converged first angle, opening and closing the mandrel (12) respectively, characterized in that,
the base section (18) comprises a crenellated rim (19) with slots (23) between adjacent crenellations,
the plurality of spokes (14) are pivotally mounted in the slots (23) between adjacent crenellations of the rim (19) by pins (21) whereby the spokes (14) can only pivot radially from a closed cone shaped position to an open expanded essentially cylindrical position with respect of the base section (18), and vice versa, and comprising,
a closing device (20) (34) (120) exerting tension on the spokes to maintain the mandrel normally in a closed position and whereby when the mandrel is opened by a drive mechanism in contact with the spokes, the device will urge the mandrel to close as the drive mechanism is retracted from the spokes.

2. A mandrel as in claim 1, wherein the base section (18) is annular.

3. A mandrel as in claim 1, for easy mounting of rubber boots bellows and seals over mechanical joints of an automobile without dismantling the joints.

4. A mandrel as in claim 1, wherein the closing devise exerts tension on the spokes near their pivot points.

5. A mandrel as in claim 1, wherein the closing device is a rubber guard element (20) covering at least a portion of the spokes (14) and the rim (19) thereby also protecting the pivot joints.

6. A mandrel as in claim 1, wherein the closing device is a plurality of springs (34).

7. A mandrel as in claim 1 wherein the closing devise is a rubber boot.

8. A mandrel as in claim 1, comprising between 3 and 12 spokes, equally or not equally spaced apart.

9. A mandrel as in claim 1, wherein the spokes (14) are detachable from the rim (19).

10. A tool (10) for expanding flexible rubber boots such as cv boots, bellows and seals for easy mounting over and removing from mechanical joints in automobiles, comprising a mandrel (12) as in claim 1, and including a drive mechanism for contacting the spokes (26) to open the mandrel, said drive mechanism reciprocating between a forward position and a backward position, whereby when the drive mechanism reciprocates in one direction it causes the spokes (14) to pivot from a first converged angle to a second open angle, and when the mechanism reciprocates in the opposite direction it allows the mandrel to close to its normal position.

11. A tool as in claim 10, wherein the drive mechanism comprises a piston (26) provided with a connector (38) for connecting to a fluid pressure source for driving the piston (26).

12. A tool as in claim 11, wherein the connector (38) is a quick fit connector for coupling to a hydraulic or pneumatic source a hydraulic or pneumatic source.

13. A tool as in claim 11, further comprising a fluid flow regulator (70) attachable to the connector (38) and to a compressor.

14. A method for expanding elastic sleeves such as cv boots or bellows and mounting same over mechanical joints of automobiles without dismantling the joints, comprising the following steps:
I. providing a tool comprising:
a) a mandrel (12), comprising:
1) a base section (18) having a crenellated rim (19) with slots (23) between adjacent crenellations,
2) a plurality of spokes (14) pivotally mounted in slots (23) between adjacent crenellations of the rim (19) by pins (21), whereby the spokes (14) can only pivot radially from a closed cone shaped position to an open expanded essentially cylindrical position, with respect of the base section (18), and vice versa, and
3) closing device (20) (34) (120) exerting tension on the spokes to maintain the mandrel normally in a closed position, and
b) drive mechanism for driving a piston (26) in contact with the spokes to reciprocate between a forward position and a backward position for opening the mandrel and causing the spokes (14) to move from a first converged angle to a second open angle,
II. sliding an elastic sleeve element such as a cv boot or bellows (50) over the plurality of spokes (14) of the mandrel when the spokes (14) are in a closed position;
III. extending the piston of the drive apparatus (26) to urge the spokes (14) to pivotally diverge radially outward, thereby expanding the elastic sleeve (50) and providing an enlarged inner sleeve cavity;
IV. placing the mandrel (12) with the diverged spokes (14) supporting the expanded elastic sleeve (50) over a mechanical joint, so that the mechanical joint lies within the enlarged inner cavity; and
V. retracting the piston (26) whereby the closing device urges the spokes (14) to converge, allowing the elastic sleeve (50) to contract over and around the mechanical joint, and withdrawing the mandrel (12), leaving the mechanical joint enveloped by the sleeve (50).

15. A method as in claim 14, wherein said drive mechanism is a pneumatically or a hydraulically driven piston.

16. A method as in claim 14, wherein the closing device is selected from the group consisting of a rubber guard element covering the base ends of the spokes and the rim and a plurality of springs.
